(19) United States
(12) Patent Application Publication
(10) Pub. No.: US 2006/0250714 A1
(43) Pub. Date: Nov. 9, 2006

(54) Switchable magnetic device

(76) Inventor: Felix von Limburg, Magdeburg (DE)

Correspondence Address: FLYNN THIEL BOUTELL & TANIS, P.C., 2026 RAMBLING ROAD, KALAMAZOO, MI, 49008-1631, US

(21) Appl. No.: 11/402,208

(22) Filed: Apr. 11, 2006

(30) Foreign Application Priority Data
May 6, 2005 (DE) 102005021094.5

(51) Int. Cl. G11B 5/00

(52) U.S. Cl. 360/1

(57) ABSTRACT

The invention relates to a switchable magnetic device for securing a formwork device on a magnetizable formwork support, comprising a magnetic means generating a magnetic force and an at least section-wise magnetizable support means by which the magnetic means is supported on the formwork support at least indirectly when the magnetic device is placed on the formwork support, wherein the magnetic device is switchable between a first position, in which the support means transmits the magnetic force to the formwork support as to secure the magnetic device on the formwork support, and a second position, in which the transmission of the magnetic force between the magnetic means and the formwork support is substantially interrupted, so that the magnetic device can be lifted off the formwork support.

The invention relates to a magnetic device for securing a formwork device on a magnetizable formwork support.

Magnetic devices for securing a formwork device on a magnetizable formwork support are known from the prior art, which can be transferred between a lowered position, in which the magnetic device is adjacent to the formwork support, and a lifted position, in which the magnetic device is spaced away from the formwork support.

Such magnetic devices have the disadvantage that, when transferring them between the lowered position and the lifted position, the enormous magnetic forces exerted by the magnetic device on the formwork support have to be overcome. Although corresponding means, e.g. eccentric levers, have already been provided in the prior art to overcome such magnetic forces as smoothly as possible, e.g. when the magnetic device is lifted off the formwork support, large forces occur above all when placing the magnetic device down, as a result of which the magnetic device is drawn onto the formwork support in a jerky manner. The jerky or respectively impulsive movement, especially when the magnetic device is placed onto the formwork support, can dislocate an already positioned formwork device and require a new positioning, which is generally not desired and takes a lot of time.

To eliminate this problem, the invention provides for a switchable magnetic device for securing a formwork device on a magnetizable formwork support, comprising a magnetic means generating a magnetic force and an at least section-wise magnetizable support means by which the magnetic means is supported on the formwork support at least indirectly when the magnetic device is placed on the formwork support, wherein the magnetic device is switchable between a first position, in which the support means transmits the magnetic force to the formwork support as to secure the magnetic device on the formwork support, and a second position, in which the transmission of the magnetic force between the magnetic means and the formwork support is substantially interrupted, so that the magnetic device can be lifted off the formwork support. The magnetic means is not itself brought in contact with the formwork support, because the magnetic means magnetizes the support means at least section-wise and the magnetic force is transmitted via the support means to the formwork support. A particularly great magnetic force acts on the magnetizable sections, e.g. the formwork support, which are traveled through by magnetic field lines, if the magnetic field lines are guided between the magnetic poles in a closed line through magnetizable material, e.g. steel. This magnetic force is reduced abruptly if the closed line between the poles is interrupted. For this purpose, for instance, a non-magnetizable material may be disposed between the magnetic means and the formwork support, or the magnetic means and the support means may be moved relative to each other and spaced away from each other. By this, the magnetic force acting on the formwork support is reduced considerably, and the magnetic device can be lifted off without problems.

For transferring the magnetic device between the first and second positions it has proved to be advantageous if the magnetic means and the support means are at least section-wise movable to each other.

The transfer of the magnetic device between the first and second positions turns out to be particularly easy if the magnetic means and the support means are relatively movable to each other, at least section-wise, in a translational motion. By this, the magnetic device may be transferred, e.g. by a simple linear hand movement, between the first and the second positions.

If the support means is at least section-wise disposed between the magnetic means and the formwork support in the first position, the distance between the magnetic means and the formwork support to be covered by the support means is the smallest, and the magnetic force generated by the magnetic means and acting on the formwork support is the greatest.

To interrupt the transmission of the magnetic force to the formwork support in a particularly easy and efficient manner, it has proven to be particularly helpful if the magnetic device comprises at least one non-magnetizable shielding device.

The support means has the function to transmit the magnetic force to the formwork support in the first position of the magnetic device, and to interrupt the transmission of the magnetic force between the magnetic means and the formwork support in the second position. These two functions can particularly easily be achieved if the support means comprises at least one non-magnetizable shielding device and, in the first position, a magnetizable section of the support means is disposed between the magnetic means and the formwork support while, in the second position, a non-magnetizable section of the support means is disposed between the magnetic means and the formwork support.

The interruption in the transmission of the magnetic force between the magnetic means and the formwork can also be achieved particularly easily if the magnetic means and the shielding device are relatively movable to each other at least section-wise.

To interrupt the transmission of the magnetic force between the magnetic means and the formwork support in a particularly easy and efficient manner, it has proved to be helpful if the shielding device is disposed, at least section-wise, between the magnetic means and the formwork support and/or between the magnetic means and the support means in the second position. At the interfaces between the magnetic means and the support means and, respectively, between the magnetic means and the formwork support the transmission of the magnetic force to the formwork support can be interrupted particularly easily by interposing a non-magnetizable section.

The transmission of the magnetic force between the magnetic means and the formwork support is particularly good in the first position of the magnetic device if the magnetic and magnetizable sections are in direct contact. Therefore, it can considerably improve the transmission of the magnetic force from the magnetic means to the support means in the first position of the magnetic device if the magnetic means has at least one contact surface and if the support means has at least one contact surface, with the contact surface of the magnetic means and the contact surface of the support means being contiguous at least section-wise in the first position.

If the support means comprises at least one magnetizable section and at least one non-magnetizable section, the magnetizable or the non-magnetizable section can—in dependence on the preferred position of the magnetic device—be disposed between the magnetic means and the formwork support, so as to optionally transmit the magnetic force between the magnetic means and the formwork support or interrupt the transmission.

In a preferred embodiment of the invention the magnetic device comprises a housing and a unit movable with respect to the housing, wherein the housing includes the support means and the movable unit includes the magnetic means. The housing can be placed on the formwork support so that the support means is adjacent to the formwork support, while the magnetic means, being a movable unit, is spaced away from the formwork support and is movable between the first and second positions relative to the support means, for transferring the magnetic device.

In a particularly preferred embodiment the support means comprises at least two contact sides, wherein at least one of the contact sides is at least indirectly adjacent to the formwork support when the magnetic device is placed on the formwork support. The magnetic device can, for instance, act on the formwork support with a different holding force, if the contact sides have differently sized contact surfaces.

If the contact sides of the support means are arranged substantially at right angles to one another the second contact side is, for instance, suited to be brought in contact with a magnetizable formwork device, so as to fix the formwork device on the formwork support.

The influence on surrounding objects by the magnetic force of the magnetic means can be reduced if the magnetic device comprises a non-magnetizable cover.

The fixation of the formwork device on the formwork support turns out to be particularly easy if the magnetic device comprises a connecting device for connecting the formwork device. This connecting device is advantageously designed as an adapter so as to be compatible with a plurality of formwork devices. The support means having a second contact side is, for instance, also designed as a connecting device so as to connect a magnetizable formwork device and to retain it in contact with the formwork support by the magnetic force.

The number of required components of a formwork device can be reduced if the magnetic device is designed as a formwork device and/or comprises at least one formwork surface.

If the magnetic device is switchable from a side opposite the contact side, the operation of the magnetic device is facilitated considerably, and the sides of the magnetic device adjacent to the contact side may be designed as formwork surfaces.

Below, the preferred embodiments of the invention are described with reference to the attached drawings.

### SHORT DESCRIPTION OF THE DRAWINGS

FIG. 1 shows a top view of the magnetic device of the first embodiment.

FIG. 2 shows a front view of the magnetic device of the first embodiment.

FIG. 3 shows a side view of the magnetic device of the first embodiment.

FIG. 4 shows a section IV-IV of the magnetic device of the first embodiment along line IV-IV of FIG. 3.

FIG. 5 shows a section V-V of the magnetic device of the first embodiment along a line V-V of FIG. 4, with the magnetic device being in the first position.

FIG. 6 shows a section VI-VI of the magnetic device of the first embodiment along a line VI-VI of FIG. 5.

FIG. 7 shows a sectional view of the magnetic device of the first embodiment comparable with FIG. 5, with the magnetic means being displaced with respect to the first position.

FIG. 8 shows a sectional view of the magnetic device of the first embodiment comparable with FIG. 5, with the magnetic device being in the second position.

FIG. 9 shows a top view of the magnetic device of the second embodiment.

FIG. 10 shows a front view of the magnetic device of the second embodiment.

FIG. 11 shows a side view of the magnetic device of the second embodiment.

FIG. 12 shows a section XII-XII of the magnetic device of the second embodiment along line XII-XII of FIG. 11.

FIG. 13 shows a section XIII-XIII of the magnetic device of the second embodiment along a line XIII-XIII of FIG. 12, with the magnetic device being in the first position.

FIG. 14 shows a section XIV-XIV of the magnetic device of the second embodiment along a line XIV-XIV of FIG. 12.

FIG. 15 shows a sectional view XV-XV of the magnetic device of the second embodiment along a line XV-XV of FIG. 13.

FIG. 16 shows a sectional view of the magnetic device of the second embodiment comparable with FIG. 13, with the magnetic means being in a position displaced with respect to the first position.

FIG. 17 shows a sectional view of the magnetic device of the second embodiment comparable with FIG. 13, with the magnetic device being in the second position.

FIG. 18 shows the magnetic device of the first embodiment installed in a first formwork device in a top view.

FIG. 19 shows the magnetic device of the first embodiment installed in the first formwork device in a front view.

FIG. 20 shows the magnetic device of the first embodiment installed in the first formwork device in a side view.

FIG. 21 shows the altered magnetic device of the first embodiment installed in a first formwork device in a top view.

FIG. 22 shows the magnetic device of the first embodiment installed in the first formwork device in a front view.

FIG. 23 shows the altered magnetic device of the first embodiment installed in the first formwork device in a side view.

FIG. 24 shows the altered magnetic device of the first embodiment installed in the first formwork device in a sectional view along a line XXIV-XXIV in FIG. 21.

FIG. 25 shows the altered magnetic device of the first embodiment installed in a second formwork device in a top view.

FIG. 26 shows the altered magnetic device of the first embodiment installed in the second formwork device in a front view.

FIG. 27 shows the altered magnetic device of the first embodiment installed in the second formwork device in a side view.

FIG. 28 shows the altered magnetic device of the first embodiment installed in the second formwork device in a sectional view along a line XXVIII-XXVIII in FIG. 25.

### DETAILED DESCRIPTION OF THE DRAWINGS

In the following description expressions indicative of a position like “at the top”, “at the bottom”, “left”, “right” or the like will be used, which help the better understanding of the description of the invention. These designations indicative of a position are each to be understood with reference to the respective illustration of the drawing only, and have no binding character beyond this.

Within the limits of the invention, the designation “magnetizable section” refers to a section which has at least one magnetizable material and is preferably made of steel. The designation “non-magnetizable section” or respectively “shielding section” refers to a section which comprises substantially one or more non-magnetizable materials, such as aluminum.

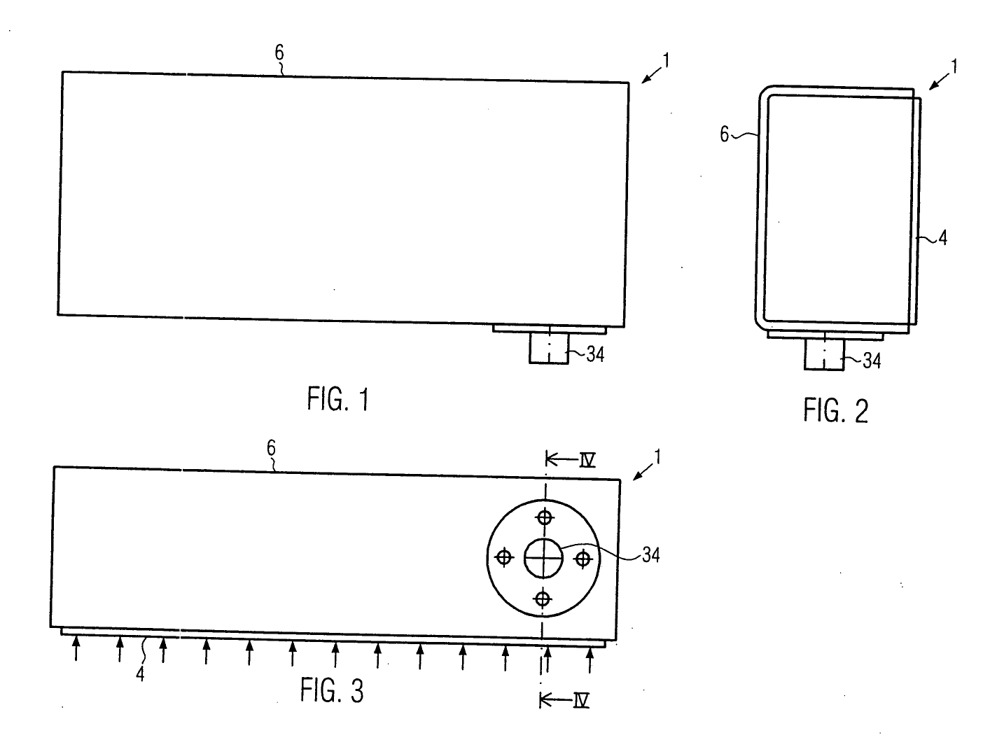

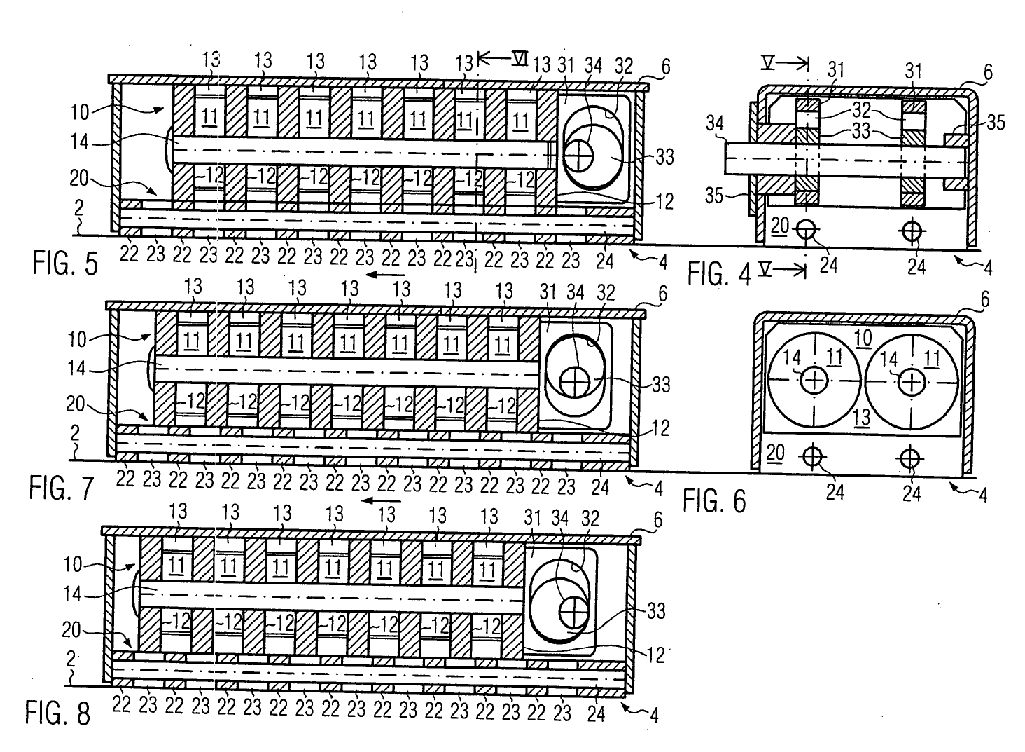

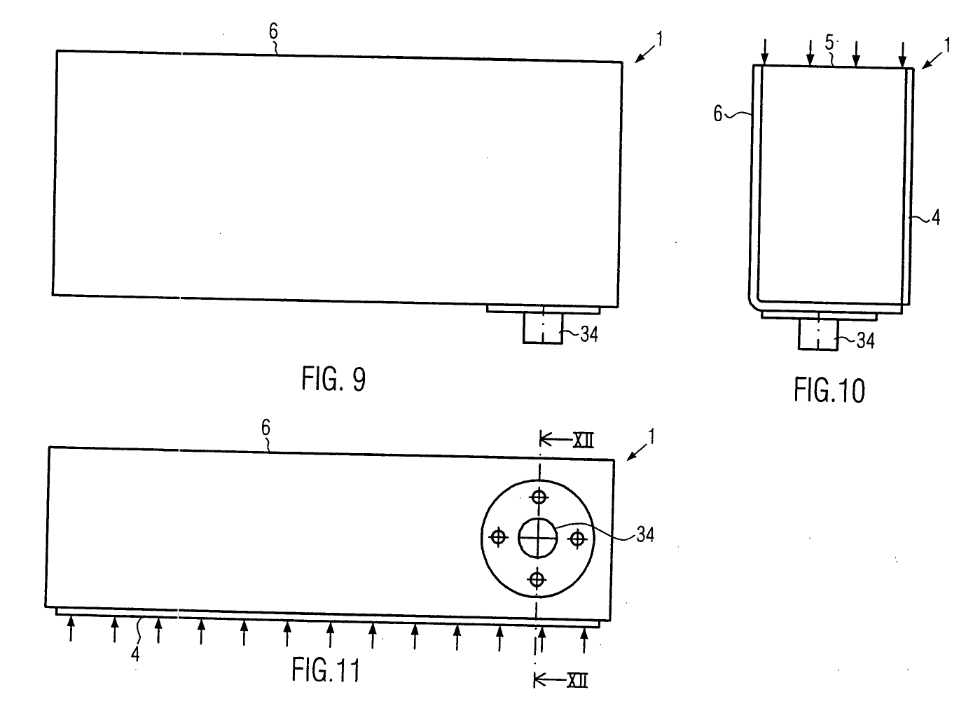

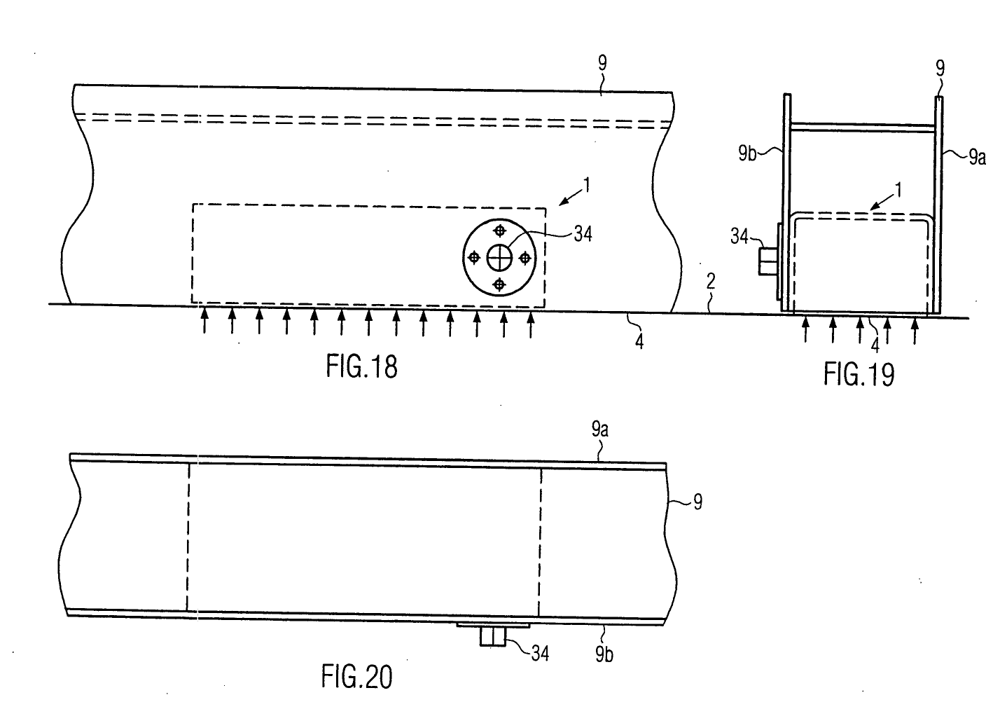

FIGS. 1 to 8 relate to the first embodiment, while FIGS. 9 to 17 relate to the second embodiment. With reference to FIGS. 18 to 28 preferred cases of application are described, in which a formwork device 9 is secured on a formwork support 2 by means of the magnetic device 1 according to the invention. First the common features of the embodiments of the magnetic device 1 according to the invention will be described, before the differences will be entered into in detail.

The invention relates to a switchable magnetic device 1 for securing a formwork device 9 on a magnetizable formwork support 2, comprising at least one magnetic means 10 generating a magnetic field and at least one at least section-wise magnetizable support means 20, by which the magnetic means 10 is supported on the formwork support 2 at least indirectly when the magnetic device 1 is placed on the formwork support 2. The magnetic device 1 is switchable between a first position, which is particularly shown in FIG. 5 and FIG. 13, and a second position, which is particularly shown in FIG. 8 and FIG. 17.

In the first position, the magnetic force generated by the magnetic means 10 is transmitted from the support means 20 to the formwork support 2 so as to secure the magnetic device 1 and the formwork device 9 on the formwork support 2.

In the second position, the transmission of the magnetic force between the magnetic means 10 and the formwork support 2 is substantially interrupted, so that the magnetic device 1 can be lifted off the formwork support 2. For transferring the magnetic device 1 between the first and second positions, the magnetic means 10 and the support means 20 are movable relative to each other along and opposite the arrows shown in FIGS. 7, 8, 16 and 17 in a translational manner.

In the second position of the magnetic device 1 non-magnetizable shielding devices 13, 23 are disposed between the magnetic means 10 and the formwork support 2 and between the magnetic means 10 and support means 20 as to interrupt the transmission of the magnetic force between the magnetic means 10 and the formwork support 2. As shielding devices 13, 23 the non-magnetizable shielding sections 13 and 23, respectively, are provided in the magnetic device 1 according to the invention. The shielding sections 13 are associated with the magnetic means 10 as a first shielding device 13, and the shielding sections 23 are associated with the support means 20 as a second shielding device 23. In the second position of the magnetic device 1 shown in FIGS. 8 and 17 the shielding sections 13 of the magnetic means 10 are disposed between the magnetic sections 11 and the magnetizable sections 22 of the support means 20, and the shielding sections 23 of the support means are disposed between the magnetizable sections 12 of the magnetic means 10 and the formwork support 2. The transmission of the magnetic force from the magnetic sections 11 to the formwork support 2 is thereby interrupted, and the magnetic force acting on the formwork support 2 is very small, so that the magnetic device 1 can be lifted off the formwork support 2 without problems.

The magnetic device 1 comprises, in addition to the magnetic means 10 and the support means 20, an adjustment mechanism 30 to move the magnetic means 10 and the support means 20 relative to each other and to transfer the magnetic device 1 from the first position into the second position, as well as a non-magnetizable housing cover 6, e.g. of special steel, which fully surrounds the magnetic device 1, with the exception of the contact side(s) 4 (5) of the support means 20.

The features of the support means 20 are described below. The support means 20 comprises several magnetizable sections 22 placed successively in an alternating sequence, and several intermediate shielding sections 23 having the same profile which are penetrated and held together by oblong pin-shaped connecting elements 24, as is graphically shown in FIGS. 5, 7, 8 and 13, 16, 17 respectively,

The magnetizable sections 22 are substantially made of steel, and the non-magnetizable sections 23 are substantially made of aluminum. The magnetizable sections 22 and the non-magnetizable sections 23 are flatly placed against each other with their confronting surfaces, wherein the exposed surfaces are substantially flush with each other and are in alignment with each other. The magnetizable sections 22 and the non-magnetizable sections 23 are penetrated by the connecting pins 24 vertically to the surfaces confronting each other, so that the support section 20 results in a total profile composed of a plurality of individual profiles 22, 23.

In the following, the features of the magnetic means 10 will be described. The magnetic means 10 of both embodiments comprises a plurality of magnetic sections 11, a plurality of rectangular magnetizable sections 12, and a plurality of rectangular non-magnetizable shielding sections 13, wherein the sections 11, 12, 13 are penetrated and held together by pin-shaped connecting elements 14. The magnetic means 10 composed of a plurality of individual profiles 11, 12, 13 substantially has the shape of a rectangular block. The magnetic sections 11 are substantially cylindrical permanent magnets 11 with a central through hole. Two cylindrical permanent magnets 11 are fitted into correspondingly shaped openings of the non-magnetizable shielding section 13, wherein the entire circumference of the cylindrical surface areas of the permanent magnets 11 is surrounded by the respective shielding section 13. The outer edges of the shielding section 13 substantially define a cuboid of the same width and length as the magnetizable sections 12 and the same thickness as the magnetic sections 11. The surfaces of the cylindrical permanent magnets 11 at the axial end sides end on either side with the corresponding surfaces of the shielding section 13 enclosing the same in a flush manner. A magnet unit consisting of two magnets 11 and one shielding section 13 is disposed between two magnetizable sections 12, wherein the surfaces of the identically sized front faces of the magnet units and the magnetizable sections 12 are contiguous. The magnetizable sections 12 are likewise provided with through holes, which are adjusted to the through holes of the magnetic sections 11 in number, position and size, and which are penetrated by the connecting elements 14. The surfaces of the magnetic sections 11 of the magnet unit 10 are held in contact with the adjacent magnetizable sections 12 to magnetize the same. The magnetic sections 11 are each arranged in a unidirectional manner, and the magnetic axes are arranged parallel to each other. Thus, the magnetic effect of the individual magnetic sections 11 is intensified. In this way a plurality of magnetic sections 12 and magnet units are successively lined up in an alternating order. Two magnetizable sections 12 form the outermost links of this lined-up link chain.

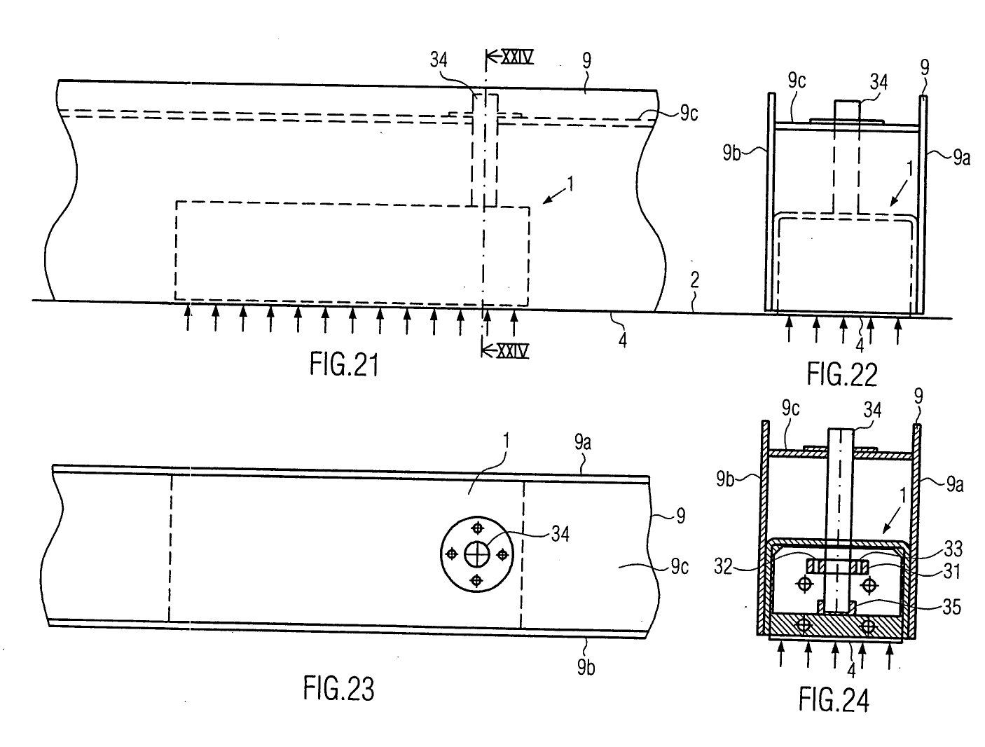

On the right one of the two outermost magnetizable sections 12 in FIGS. 5, 7, 8 and 13, 16, 17, respectively, accommodating sections 31 with oval accommodating openings 32 are affixed, e.g. by welding. The accommodating sections 31 are provided to accommodate an eccentric 33 mounted on a pivot 34 projecting towards the outside of the housing 6. The pivot 34 may be mounted in different ways, depending on the preferred embodiment. In the embodiments described with reference to FIGS. 1 to 20 the pivot 34 is mounted parallel to a bearing side or respectively surface 4 of the magnetic device 1, whereas—with respect to the embodiments described in FIGS. 21 to 28—it is aligned vertically to the bearing side or respectively surface 4 of the magnetic device 1.

In the first embodiment according to the invention shown in FIGS. 1 to 8 the support means 20 has a substantially flat rectangular shape with a contact side 4 to be brought in contact with the formwork support 2, wherein the support means 20 is composed of rectangular magnetizable sections 22 and rectangular non-magnetizable sections 23. This is particularly graphically illustrated in FIGS. 2, 4 and 6.

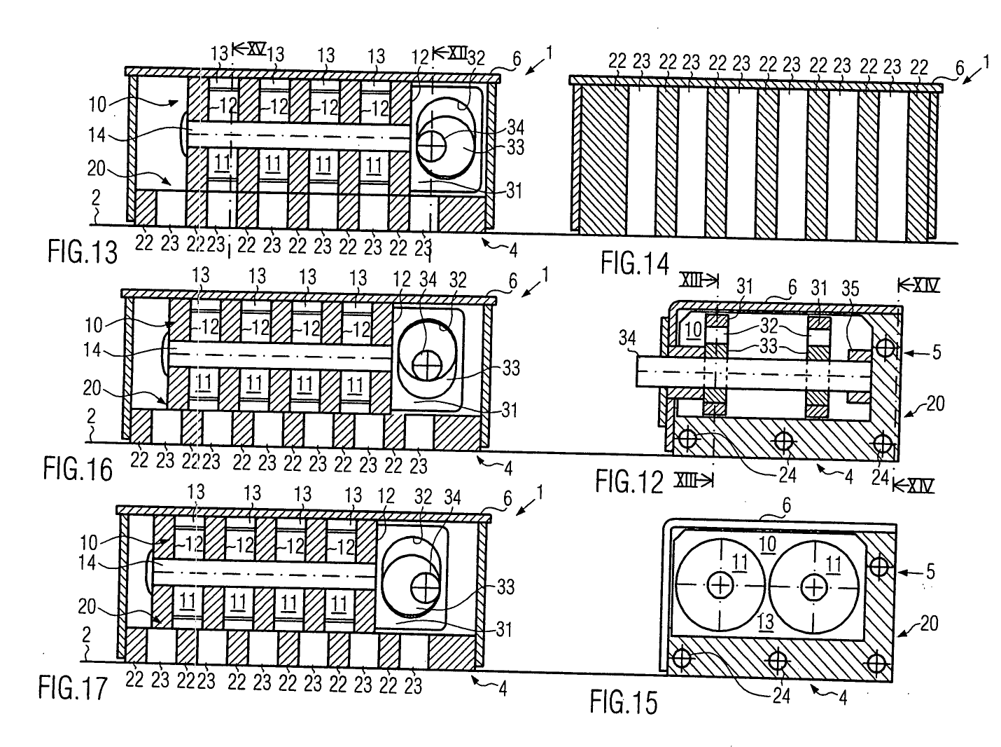

In the second embodiment of the invention the support means has a substantially L-shaped cross-section, which is particularly graphically illustrated in FIGS. 12 and 15. The magnetizable sections 22 of steel as well as the non-magnetizable sections 23 of aluminum thereby each have an L-shaped configuration and are connected to form the oblong L-shaped profile of the support means 20 by means of pin-shaped connecting elements 24. The magnetic device 1 or, respectively, the support means 20 thereby have a first contact side 4 to be brought in contact with the formwork support 2, and a second contact side 5 on which, for instance, a magnetizable formwork device may be mounted. The second contact side 5 is formed as an adapter for connecting an optional magnetizable object to the magnetic device 1, and forms, for instance, a connecting device for connecting a formwork device to the magnetic device 1. The magnetic device 1 may also be designed as a formwork device itself, by providing a formwork surface on the housing of the magnetic device 1. Alternatively, a formwork device 9 is placed on the magnetic device 1 according to the invention, or the inventive magnetic device 1 is installed in a formwork device 9, which will be described with reference to FIGS. 18 to 28 below.

FIGS. 18 to 20 show a top view, a front view and a side view of the inventive magnetic device 1 of the above-described first embodiment installed in a first formwork device 9. The formwork device 9 comprises an element having a H-shaped cross-section, whereof the legs 9a,9b are, at the inner sides, brought in contact with the outer sides of the legs of the housing cover 6—as is shown in FIG. 19—, wherein the pivot 34 projects through a corresponding opening in the left leg 9b of the formwork device 9 and is operable from outside. In the state where the magnetic device 1 is placed upon the formwork support 2 the legs 9a and 9b extend substantially vertically to the surface of the formwork support 2. The outer side of the leg 9a is formed as a formwork surface.

FIGS. 21 to 24 show a top view, a front view, a side view or respectively sectional view of the altered magnetic device 1 of the first embodiment installed in the first formwork device 9. Like in the above case, the formwork device 9 comprises an element having a H-shaped cross-section, whereof the legs 9a, 9b are, at the inner sides, brought in contact with the outer sides of the legs of the housing cover 6—as is shown in FIG. 19. However, the magnetic device 1 is altered with respect to the above-described first embodiment, with the adjustment mechanism 30, comprising the accommodating section 31, the receptacle 32, the eccentric 33, the pivot 34 and the bearing section 35, being offset by 90°. FIG. 24 shows the arrangement of the adjustment mechanism 30 particularly graphically in a sectional view. The pivot 34 projects through respective openings in the housing cover 6 or, respectively, in a web 9c of the formwork device 9 connecting the legs 9a and 9b, and is switchable between the first and second positions from a side of the magnetic device 1 opposite the contact side 4. On the one hand, this has the advantage that the magnetic device 1 is easier to operate and, on the other hand, that the outer surfaces of the two legs 9a and 9b of the formwork device 9 may be provided as formwork surfaces.

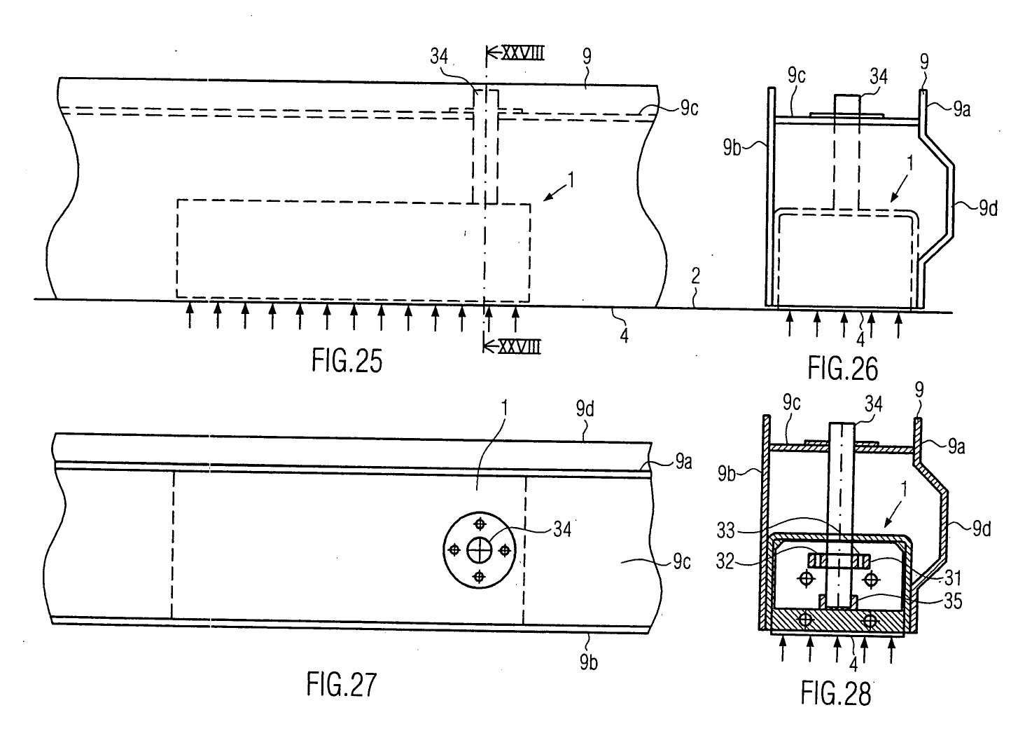

FIGS. 25 to 28 show a top view, a front view, a side view or respectively sectional view of the altered magnetic device 1 of the first embodiment installed in a second formwork device 9. In contrast to the preceding case of application described with reference to FIGS. 21 to 24, the formwork device 9 is altered. It is graphically illustrated especially in FIGS. 26 and 28 how the leg 9a of the formwork device 9 is provided with a bulge 9d having a trapezoidal cross-section and only the lower part of the inner side of the leg 9a is held in contact with the outer side of the housing cover 6 of the magnetic device 1. The outer surface of the bulged leg 9a is likewise designed as a formwork surface, so that the formwork device 9 provides two different formwork surfaces.

Below the preferred use of the invention will be described with reference to the attached drawings.

For securing the magnetic device 1 and the formwork device 9 on the formwork support 2 the magnetic device 1 is at first placed upon the formwork support 2 and is transferred from the second position into the first position.

The magnetizable sections 12 of the magnetic means 10 and the magnetizable sections 22 of the support means 20, which are adjusted to each other in number and size, are thereby arranged directly side by side, so that the contact surfaces of the magnetizable sections 12 of the magnetic means 10 and the contact surfaces of the magnetizable sections 22 of the support means 20 rest flatly on each other. As the magnetizable sections 22 of the support means 20, just like the non-magnetizable sections 23, are at least indirectly supported on the formwork support 2, the magnetic force generated by the magnetic sections 11 is, in the first position of the magnetic device 1, transmitted via the magnetizable sections 12 of the magnetic means 10 to the magnetizable sections 22 of the support means 20 and from there to the formwork support 2. Between the respective poles of the magnetic sections 11 the magnetic field lines travel through the magnetizable sections 11, 22 and through the formwork support 2 substantially in a closed line.

For transferring the magnetic device 1 between the first and second positions, the magnetic means 10 and the support means 20 are moved relative to each other by operating the adjustment mechanism 30. By pivoting the pivot 34 the eccentric 33 is set in motion and displaced in the receptacle 32 of the accommodating section 31, wherein the magnetic means 10 is moved relative to the support means 20 in a translational movement.

In the views shown in FIGS. 3, 11 and 18 the pivot 34 projects vertically to the image plane over the housing cover 6 and can be operated manually or with a special tool from outside the housing cover 6. The pivot 34 is thereby pivoted clockwise about an axis perpendicularly to the image plane of FIGS. 5, 13 and 18. The image sequences of FIGS. 5, 7 and 8 as well as of FIGS. 13, 16 and 17 illustrate the sequence of motions of the magnetic means 10 with respect to the support means 20 from the first into the second position.

In the cases of application shown in FIGS. 21 to 28 the adjustment mechanism 30 or, respectively, the pivot 34 is operated from a side of the magnetic device 1 opposite the contact side 4. In the views shown in FIGS. 22, 24, 26 and 28 the pivot 34 extends perpendicularly to the surface of the formwork support 2 and projects over the housing cover 6 and the web 9c connecting the legs 9a and 9b of the formwork device 9, so that it can be operated manually or with a special tool from outside the formwork device 9. The adjustment of the magnetic device 1 between the first and second positions is accomplished according to the principle illustrated in FIGS. 5, 7, 8 and, respectively, 13, 16 and 17.

When transferring the magnetic device 1 from the first into the second position the magnetic means 10 is displaced with respect to the support means 20. As was described above, the shielding sections 13 of the magnetic means 10 are thereby arranged between the magnetic sections 11 and the magnetizable sections 22 of the support means 20, and the shielding sections 23 of the support means 20 are arranged between the magnetizable sections 12 of the magnetic means 10 and the formwork support 2, so that the transmission of the magnetic force from the magnetic sections 11 to the formwork support 2 is interrupted. As is illustrated in FIGS. 8 and 17, the contact surfaces of the magnetizable sections 12 of the magnetic means 10 and the magnetizable sections 22 of the support means 20 do not overlap, because the non-magnetizable sections 13, 23 have a greater expansion in the direction of movement of the magnetic means 10 from the first into the second position than the magnetic sections 12, 22.

Even though the transmission of magnetic force from the magnets 10 to the formwork support 2 is, strictly speaking, not completely interrupted when the magnetic device is transferred from the first into the second position, because a minimum magnetic force of the magnetic sections 11 still acts on the formwork support 2 despite a best possible shielding, the transmission of the magnetic force from the magnets 11 to the formwork support 2 is limited to such an extent that the magnetic force acting on the formwork support 2 is substantially reduced and the magnetic device 1 can therefore easily be lifted off the formwork support 2.

The embodiments according to the invention shown in FIGS. 1 to 28 are, of course, only a small selection out of a plurality of possible embodiments which may be realized within the limits of the invention under the protection of the attached protection claims.

1. Switchable magnetic device (1) for securing a formwork device (9) on a magnetizable formwork support (2), comprising a magnetic means (10) generating a magnetic force and an at least section-wise magnetizable support means (20) by which the magnetic means (10) is supported on the formwork support (2) at least indirectly when the magnetic device (1) is placed on the formwork support (2), wherein the magnetic device (1) is switchable between a first position, in which the support means (20) transmits the magnetic force to the formwork support (2) as to secure the magnetic device (1) on the formwork support (2), and a second position, in which the transmission of the magnetic force between the magnetic means (10) and the formwork support (2) is substantially interrupted, so that the magnetic device (1) can be lifted off the formwork support (2).

2. Switchable magnetic device (1) according to claim 1, characterized in that the magnetic means (10) and the support means (20) are relatively movable to each other at least section-wise.

3. Switchable magnetic device (1) according to claim 1, characterized in that the magnetic means (10) and the support means (20) are relatively movable to each other at least section-wise in a translational movement.

4. Switchable magnetic device (1) according to claim 1, characterized in that the support means (20) is arranged at least section-wise between the magnetic means (10) and the formwork support (2) in the first position.

5. Switchable magnetic device (1) according to claim 1, characterized in that the magnetic device comprises at least one non-magnetizable shielding device (13, 23).

6. Switchable magnetic device (1) according to claim 1, characterized in that the support means (20) comprises at least one non-magnetizable shielding device (23).

7. Switchable magnetic device (1) according to claim 6, characterized in that the magnetic means (10) and the shielding device (23) are relatively movable to each other at least section-wise.

8. Switchable magnetic device (1) according to claim 5, characterized in that the shielding device (13, 23) is at least section-wise arranged between the magnetic means (10) and the formwork support (2) and/or between the magnetic means (10) and the support means (20) in the second position.

9. Switchable magnetic device (1) according to claim 1, characterized in that the magnetic means (10) comprises at least one contact surface and the support means (20) comprises at least one contact surface, wherein the contact surface of the magnetic means (10) and the contact surface of the support means (20) are contiguous at least section-wise in the first position.

10. Switchable magnetic device (1) according to claim 1, characterized in that the support means (20) comprises at least one magnetizable section (22) and at least one non-magnetizable section (23).

11. Switchable magnetic device (1) according to claim 1, characterized in that the magnetic device (1) comprises a housing and a unit movable with respect to the housing, wherein the housing includes the support means (20) and the movable unit includes the magnetic means (10).

12. Switchable magnetic device (1) according to claim 1, characterized in that the support means (20) comprises at least two contact sides (4, 5), wherein at least one contact side (4) is adjacent to the formwork support (2) at least indirectly when the magnetic device (1) is placed on the formwork support (2).

13. Switchable magnetic device (1) according to claim 12, characterized in that the contact sides (4, 5) of the support means (20) are arranged substantially at right angles to each other.

14. Switchable magnetic device (1) according to claim 1, characterized in that the magnetic device (1) comprises a non-magnetizable cover (6).

15. Switchable magnetic device (1) according to claim 1, characterized in that the magnetic device (1) comprises a connecting device 5, 20) for connecting the formwork device (9).

16. Switchable magnetic device (1) according to claim 1, characterized in that the magnetic device (1) comprises at least one formwork surface.

17. Switchable magnetic device (1) according to claim 1, characterized in that the magnetic device (1) is formed as a formwork device.

18. Switchable magnetic device (1) according to claim 12, characterized in that the magnetic device (1) is switchable from a side opposite the contact side (4, 5).
